(19) United States
(12) Patent Application Publication
(10) Pub. No.: US 2025/0138393 A1
(43) Pub. Date: May 1, 2025

(54) CAMERA MODULE

(71) Applicant: SAMSUNG ELECTRO-MECHANICS CO., LTD., Suwon-si (KR)

(72) Inventors: Chang Min PARK, Suwon-si (KR); Kyung Hun LEE, Suwon-si (KR)

(73) Assignee: SAMSUNG ELECTRO-MECHANICS CO., LTD., Suwon-si (KR)

(21) Appl. No.: 18/653,374

(22) Filed: May 2, 2024

(30) Foreign Application Priority Data
Oct. 30, 2023 (KR) 10-2023-0146329

(51) Int. Cl. G03B 9/06; G02B 7/02

(52) U.S. Cl. CPC G03B 9/06; G02B 7/025

(57) ABSTRACT

A camera module includes a housing; a lens module disposed in the housing and configured to move in one or more axial directions among three axes intersecting each other, the lens module including a lens barrel and a lens holder coupled together; and an aperture module coupled to the lens module and configured to move together with the lens module. The lens holder includes a first adhesive groove bonded to the lens barrel and a second adhesive groove including a portion of the aperture module accommodated therein. A barrier member is disposed between the first adhesive groove and the second adhesive groove.

### CROSS-REFERENCE TO RELATED APPLICATIONS

This application claims the benefit under 35 USC 119(a) of Korean Patent Application No. 10-2023-0146329 filed on Oct. 30, 2023, in the Korean Intellectual Property Office, the entire disclosure of which is incorporated herein by reference for all purposes.

### BACKGROUND

### 1. Field

The present disclosure relates to a camera module.

### 2. Description of Related Art

A camera module has been employed in portable electronic devices such as smartphones, tablet PCs, and laptops.

A mobile camera module may include an aperture module for controlling the amount of light.

A lens module of the camera module may move for focus adjustment and image stabilization functions. In this case, in a structure where an aperture module is fixed, the distance between the lens module and the aperture module may change, making it difficult to satisfy desired driving properties.

Also, when the aperture module is configured to move together with the lens module, the coupling reliability of the aperture module and the lens module may be reduced due to the weight of the aperture module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing; a lens module disposed in the housing and configured to move in one or more axial directions among three axes intersecting each other, the lens module including a lens barrel and a lens holder coupled together; and an aperture module coupled to the lens module and configured to move together with the lens module. The lens holder includes a first adhesive groove bonded to the lens barrel and a second adhesive groove including a portion of the aperture module accommodated therein. A barrier member is disposed between the first adhesive groove and the second adhesive groove.

The lens barrel may be bonded to the lens holder by an adhesive applied to the first adhesive groove.

The aperture module may be bonded to the lens barrel and the lens holder by an adhesive applied to the second adhesive groove.

A lower surface of the aperture module may be bonded to an upper surface of the lens barrel through the adhesive.

The aperture module may include a support protrusion accommodated in the second adhesive groove. The support protrusion may be spaced apart from a bottom surface of the second adhesive groove, in an optical axial direction, while being accommodated in the second adhesive groove.

The aperture module may include a support protrusion accommodated in the second adhesive groove. The support protrusion may be spaced apart from an internal side surface of the second adhesive groove and an external side surface of the lens barrel while being accommodated in the second adhesive groove.

A distance between an internal side surface of the adhesive groove and an external side surface of the lens barrel in a direction perpendicular to an optical axis may be greater than a width of the support protrusion in the direction perpendicular to the optical axis.

An adhesive may be applied to the second adhesive groove, and the adhesive surrounds the support protrusion.

The adhesive may be in contact with the internal side surface of the second adhesive groove, an external side surface of the support protrusion, and the external side surface of the lens barrel.

The barrier member may extend in an optical axial direction to partition the first adhesive groove and the second adhesive groove.

A length of the second adhesive groove in a circumferential direction may be longer than a length of the first adhesive groove in the circumferential direction.

A portion of an external side surface of the lens barrel may oppose the first adhesive groove and the second adhesive groove in a direction perpendicular to an optical axis.

The camera module may further include a connection substrate configured to supply power to the aperture module and including a moving portion coupled to the aperture module, a fixing portion fixed to the housing, and a support portion connecting the moving portion to the fixing portion.

The camera module may further include a printed circuit board coupled to the housing and on which an image sensor is disposed. The connection substrate may further include a connection portion connecting the fixing portion to the printed circuit board.

The aperture module may include a base; a rotating body disposed to rotate with respect to the base; a plurality of blades configured to move in conjunction with rotation of the rotating body to form an aperture; a magnet portion disposed on one of the base and the rotating body; a coil portion disposed to face the magnet portion; and an aperture substrate on which the coil portion is disposed.

The camera module may further include a printed circuit board coupled to the housing and on which an image sensor is disposed; and a connection substrate having one side connected to the aperture substrate and another side connected to the printed circuit board.

The aperture module and the lens module may be configured to move together in an optical axial direction, a first axial direction perpendicular to the optical axial direction, and a second axial direction perpendicular to both the optical axial direction and the first axial direction.

Other features and aspects will be apparent from the following detailed description, the drawings, and the claims.

### BRIEF DESCRIPTION OF DRAWINGS

FIG. 1 is a perspective diagram illustrating a camera module according to an embodiment of the present disclosure.

FIG. 2 is a perspective diagram illustrating a state in which an aperture module and a camera actuator are separated from each other.

FIG. 3 is an exploded perspective diagram illustrating a camera actuator according to an embodiment of the present disclosure.

FIG. 4 is an exploded perspective diagram illustrating a lens barrel and a lens holder.

FIG. 5 is a plan diagram illustrating a state in which a lens barrel and a lens holder are coupled to each other.

FIG. 6 is an exploded perspective diagram illustrating an aperture module and a lens holder.

FIG. 7 is a cross-sectional perspective diagram and an enlarged diagram illustrating a camera module according to an embodiment of the present disclosure.

FIG. 8 is a plan diagram illustrating a connection substrate of a camera actuator.

FIG. 9 is a perspective diagram illustrating a state in which a connection substrate and a case are coupled to each other.

FIG. 10 is a perspective diagram in FIG. 9, viewed from below.

FIG. 11 is a cross-sectional diagram in FIG. 9 taken along line I-I′.

FIG. 12 is a perspective diagram illustrating a state in which a connection substrate and a case are coupled to each other.

FIG. 13 is a perspective diagram in FIG. 12, viewed from below.

FIGS. 14 to 16 are diagrams illustrating modified examples of a connection substrate.

FIG. 17 is a perspective diagram illustrating a state in which an aperture module has a relatively narrow aperture according to an embodiment of the present disclosure.

FIG. 18 is a perspective diagram illustrating a state in which an aperture module has a relatively large aperture according to an embodiment of the present disclosure.

FIG. 19 is an exploded perspective diagram illustrating an aperture module according to an embodiment of the present disclosure.

FIG. 20 is an exploded perspective diagram illustrating an example in which an aperture driving unit is disposed on a base and a rotating body.

FIG. 21 is a plan diagram illustrating a state in which a rolling portion is disposed on a base.

FIG. 22 is a perspective diagram illustrating a state in which a pulling yoke portion and an auxiliary yoke are separated from a base.

FIG. 23 is a diagram illustrating an arrangement form of a magnet portion, a pulling yoke portion and an auxiliary yoke.

FIG. 24 is a cross-sectional diagram in FIG. 17 taken along line II-II′.

FIG. 25 is a plan diagram illustrating a guide groove in which a rolling portion is disposed.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

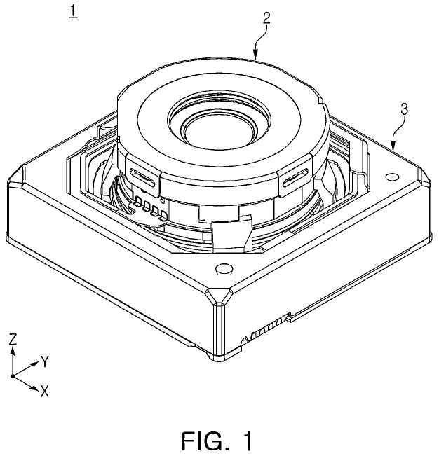

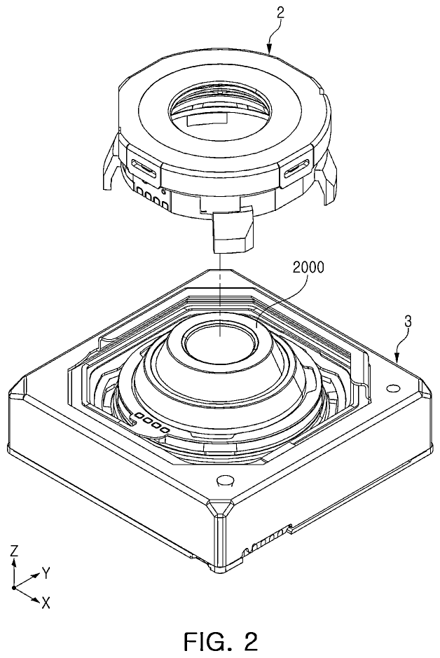

FIG. 1 is a perspective diagram illustrating a camera module according to an embodiment. FIG. 2 is a perspective diagram illustrating a state in which an aperture module and a camera actuator are separated from each other.

Referring to FIGS. 1 and 2, a camera module 1, according to an embodiment, may include an aperture module 2 and a camera actuator 3.

The camera actuator 3 may include a housing 1100 having an internal space, and a lens module 2000 disposed in the housing 1100. The lens module 2000 may move in one or more axial directions among three axes intersecting each other.

For example, the lens module 2000 may move in the optical axis (Z-axis) direction for focus adjustment. Also, the lens module 2000 may move in a direction perpendicular to the optical axis (Z-axis) for image stabilization.

The aperture module 2 may be coupled to a camera actuator 3 and may control the amount of light incident to the camera actuator 3. For example, the aperture module 2 may have an aperture 210 through which light passes, and the amount of light incident to the camera actuator 3 may be adjusted by changing the size of the aperture 210.

The aperture module 2 may be coupled to the lens module 2000 and configured to move together with the lens module 2000.

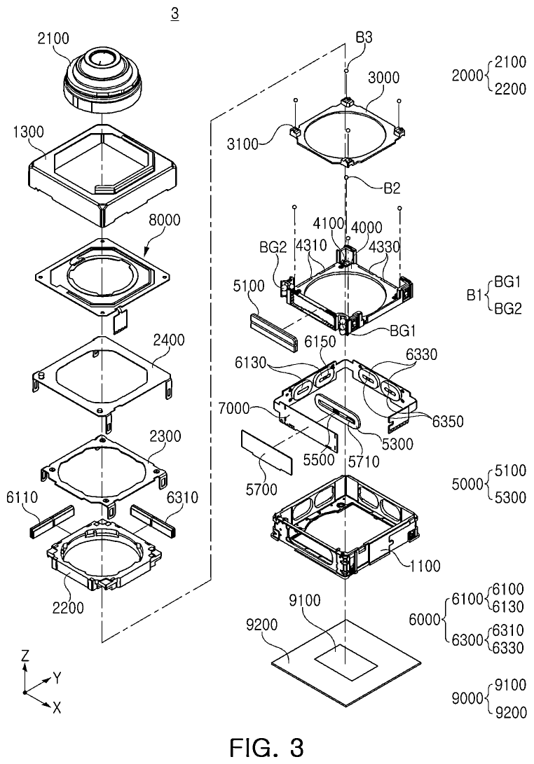

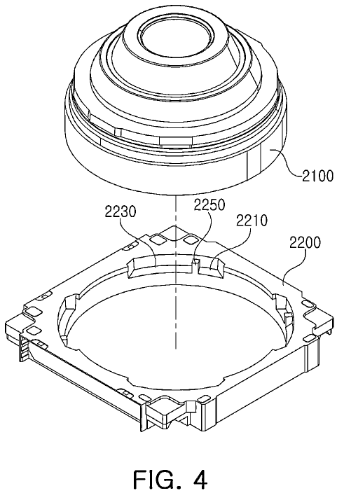

FIG. 3 is an exploded perspective diagram illustrating a camera actuator according to an embodiment. FIG. 4 is an exploded perspective diagram illustrating a lens barrel and a lens holder. FIG. 5 is a plan diagram illustrating a state in which a lens barrel and a lens holder are coupled to each other.

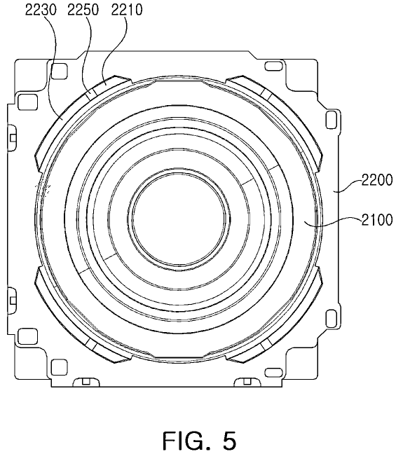

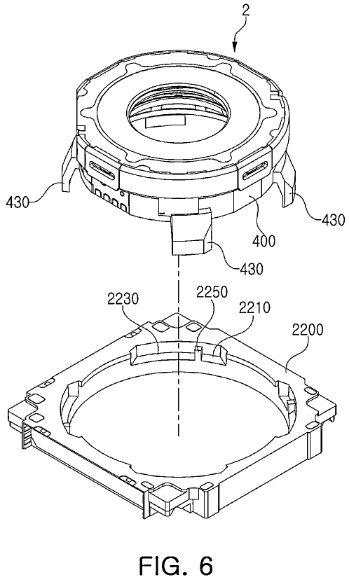

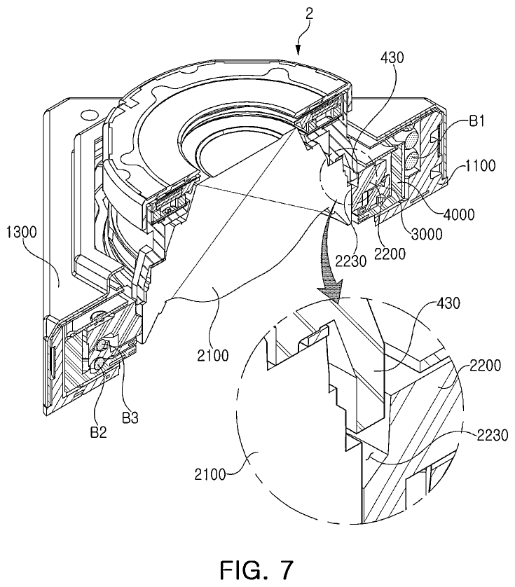

FIG. 6 is an exploded perspective diagram illustrating an aperture module and a lens holder. FIG. 7 is a cross-sectional perspective diagram and an enlarged diagram illustrating a camera module according to an embodiment.

Referring to FIG. 3, a camera actuator 3, according to an embodiment, may include a lens module 2000 and a housing 1100 accommodating the lens module 2000.

Also, the camera actuator 3 may further include a guide frame 3000, a carrier 4000, a case 1300, and an image sensor module 9000.

The carrier 4000 may be disposed in the housing 1100 and may move relative to the housing 1100 in the optical axis (Z-axis) direction.

The lens module 2000 may be disposed on the carrier 4000, and the carrier 4000 and the lens module 2000 may move together in the optical axis (Z-axis) direction. Accordingly, the distance between the lens module 2000 and the image sensor 9100 may be varied to adjust the focus.

Also, the lens module 2000 may move in a direction perpendicular to the optical axis (Z-axis) direction and may correct shaking during imaging.

The guide frame 3000 may be disposed between the carrier 4000 and the lens module 2000. The guide frame 3000 may function to guide the lens module 2000 to move in a direction perpendicular to the direction of the optical axis (Z-axis).

The lens module 2000 may include a lens barrel 2100 and a lens holder 2200. The lens barrel 2100 may have a hollow cylindrical shape, and at least one lens for imaging a subject may be accommodated in the lens barrel 2100. When a plurality of lenses are disposed, a plurality of lenses may be mounted on the lens barrel 2100 in the optical axis (Z-axis).

The lens barrel 2100 may be coupled to the lens holder 2200. Accordingly, the lens barrel 2100 and the lens holder 2200 may move together.

In an embodiment, the lens barrel 2100 may be coupled to the lens holder 2200 such that an external side surface may be in contact with an internal side surface of the lens holder 2200. For example, the lens holder 2200 may have a through-hole in the center to accommodate the lens barrel 2100.

In the embodiment below, an example in which the base 400 of the aperture module 2 may be coupled to the lens module 2000 of the camera actuator 3 will be described. In this case, the aperture module 2 may move together with the lens module 2000 as the lens module 2000 may move.

Referring to FIGS. 4 and 5, the lens holder 2200 may have a first adhesive groove 2210 formed on an internal side surface. When the lens barrel 2100 is accommodated in a through-hole of the lens holder 2200, an external side surface of the lens barrel 2100 may directly face the first adhesive groove 2210.

An adhesive may be applied to the first adhesive groove 2210, and accordingly, the lens barrel 2100 may be firmly coupled to the lens holder 2200. A plurality of first adhesive grooves 2210 may be spaced apart from each other on an internal side surface of the lens holder 2200.

Meanwhile, referring to FIGS. 6 and 7, the aperture module 2 may be coupled to the lens holder 2200. For example, the base 400 of the aperture module 2 may be coupled to the lens holder 2200.

The lens barrel 2100 may also be coupled to the lens holder 2200, but in FIG. 6, for ease of description, the lens barrel 2100 is not illustrated.

In an embodiment, the base 400 of the aperture module 2 may include a support protrusion 430 extending in the optical axis (Z-axis) direction toward the lens holder 2200. Also, the lens holder 2200 may have a second adhesive groove 2230 formed on an internal side surface.

At least a portion of the support protrusion 430 of the base 400 may be disposed in the second adhesive groove 2230 of the lens holder 2200. With the support protrusion 430 disposed on the second adhesive groove 2230, the support protrusion 430 may be spaced apart from an internal side surface of the second adhesive groove 2230 and an external side surface of the lens barrel 2100. For example, the thickness of the support protrusion 430 may be smaller than the distance between the external side surface of the lens barrel 2100 and the internal side surface of the second adhesive groove 2230.

Also, the support protrusion 430 may be disposed such that a lower surface may be spaced apart from a bottom surface of the second adhesive groove 2230.

An adhesive may be applied to the second adhesive groove 2230. The adhesive may surround the support protrusion 430. For example, the adhesive applied to the second adhesive groove 2230 may be in contact with the entirety of the external side surfaces of the second adhesive groove 2230, the support protrusion 430 and the lens barrel 2100.

Accordingly, the lens barrel 2100 and the lens holder 2200 may be more firmly coupled, and the aperture module 2 and the lens holder 2200 may also be more firmly coupled.

A plurality of second adhesive grooves 2230 may be spaced apart from each other on an internal side surface of the lens holder 2200.

A barrier member 2250 may be disposed between the first adhesive groove 2210 and the second adhesive groove 2230, which may be to prevent the adhesive from flowing into the second adhesive groove 2230 when the lens barrel 2210 is coupled to the lens holder 2200.

The barrier member 2250 may extend in the optical axis (Z-axis) direction to partition the first adhesive groove 2210 from the second adhesive groove 2230.

Meanwhile, the aperture module 2 may also be coupled to the lens barrel 2100. For example, referring to FIG. 7, a lower surface of the base 400 of the aperture module 2 may be bonded to an upper surface of the lens barrel 2100. A portion in which the aperture module 2 and the lens barrel 2100 are bonded to each other may be formed continuously in the circumferential direction of the lens barrel 2100.

In a structure where the aperture module 2 moves together with the lens module 2000, the aperture module 2 may need to be coupled to the lens module 2000. In this case, when the load of the aperture module 2 is concentrated on a specific portion of the lens module 2000, it may be highly likely that the aperture module 2 and the lens module 2000 may be separated from each other due to impact.

Accordingly, to prevent the load of the aperture module 2 from being concentrated on a specific portion, the aperture module 2 may be bonded to each of the lens barrel 2100 and the lens holder 2200 by an adhesive.

Referring to FIG. 3, the lens module 2000 may be accommodated in a housing 1100. As an example, the housing 1100 may have a shape in which an upper portion and a lower portion are open, a carrier 4000 may be disposed in an internal space of the housing 1100, and a lens module 2000 may be accommodated in the carrier 4000.

The camera actuator 3 may adjust its focus by moving the lens module 2000 in the optical axis (Z-axis) direction, and may correct shaking during imaging by moving the lens module 2000 in the direction perpendicular to the optical axis (Z-axis).

The camera actuator 3 may include a focus driving unit 5000 moving the lens module 2000 in the optical axis (Z-axis) direction, and a shaking driving unit 6000 moving the lens module 2000 in a direction perpendicular to the optical axis (Z-axis) direction.

The image sensor module 9000 may be a device for converting incident light into an electrical signal through the lens module 2000.

As an example, the image sensor module 9000 may include an image sensor 9100 and a printed circuit board 9200 connected to the image sensor 9100, and may further include an infrared filter.

The infrared filter may block light in an infrared region of light incident through the lens module 2000.

The image sensor 9100 may convert incident light into an electrical signal through the lens module 2000. As an example, the image sensor 9100 may be a charge coupled device (CCD) or a complementary metal-oxide semiconductor (CMOS).

The electrical signal converted by the image sensor 9100 may be output as an image through a display unit of a portable electronic device.

The image sensor 9100 may be fixed to the printed circuit board 9200 and may be electrically connected to the printed circuit board 9200 by wire-bonding.

The image sensor module 9000 may be disposed below the housing 1100.

A case 1300 may be coupled to the housing 1100 to surround the external surface of the housing 1100, and may function to protect the internal components of the camera actuator 3.

The focus driving unit 5000 may move the lens module 2000 to focus on a subject. For example, the focus driving unit 5000 may move the carrier 4000 by generating a driving force in the optical axis (Z-axis) direction. Since the lens module 2000 is disposed in the carrier 4000, the carrier 4000 and the lens module 2000 may move together in the optical axis (Z-axis) direction by the driving force of the focus driving unit 5000.

Also, since the base 400 of the aperture module 2 is coupled to the lens module 2000, the aperture module 2 may also move in the optical axis (Z-axis) direction together with the lens module 2000.

The focus driving unit 5000 may include a first magnet 5100 and a first coil 5300. The first magnet 5100 and the first coil 5300 may be disposed to face each other in a direction perpendicular to the optical axis (Z-axis).

The first magnet 5100 may be mounted on the carrier 4000. As an example, the first magnet 5100 may be mounted on one side surface of the carrier 4000.

The first magnet 5100 may be magnetized such that one surface (e.g., the surface facing the first coil 5300) may have both N and S poles. For example, an N pole, a neutral region and an S pole may be disposed on one surface of the first magnet 5100 facing the first coil 5300 in order in the optical axis (Z-axis) direction.

The first coil 5300 may be disposed to face the first magnet 5100. For example, the first coil 5300 may be disposed to face the first magnet 5100 in a direction perpendicular to the optical axis (Z-axis).

The first coil 5300 may be disposed on the substrate 7000, and the substrate may be mounted on the housing 1100 such that the first magnet 5100 and the first coil 5300 may face each other in a direction perpendicular to the optical axis (Z-axis). As an example, the first coil 5300 may be disposed on one surface of the substrate 7000. The substrate 7000 may be mounted on a side surface of the housing 1100 such that the first magnet 5100 and the first coil 5300 may face each other in a direction perpendicular to the optical axis (Z-axis).

The housing 1100 may include an opening, and the first coil 5300 disposed on the substrate 7000 may directly face the first magnet 5100 through an opening.

The first magnet 5100 may be a moving member mounted on the carrier 4000 and moving in the optical axis (Z-axis) direction together with the carrier 4000, and the first coil 5300 may be a fixed member fixed to the substrate 7000.

When power is applied to the first coil 5300, the carrier 4000 may move in the optical axis (Z-axis) direction by electromagnetic force between the first magnet 5100 and the first coil 5300.

Since the lens module 2000 is accommodated in the carrier 4000, the lens module 2000 may also move in the optical axis (Z-axis) direction by moving the carrier 4000. Also, the aperture module 2 may also move in the optical axis (Z-axis) direction together with lens module 2000.

The first ball member B1 may be disposed between the carrier 4000 and the housing 1100. For example, the first ball member B1 may be disposed between the carrier 4000 and the housing 1100 and may reduce friction when the carrier 4000 moves.

The first ball member B1 may include a plurality of balls disposed in the optical axis (Z-axis) direction. The plurality of balls may roll in the optical axis (Z-axis) direction when the carrier 4000 moves in the optical axis (Z-axis) direction.

The first yoke 5700 may be disposed in the housing 1100. The first yoke 5700 may be disposed in a position facing the first magnet 5100. For example, the first coil 5300 may be disposed on one surface of the substrate 7000, and the first yoke 5700 may be disposed on the other surface of the substrate 7000.

The first magnet 5100 and the first yoke 5700 may generate attractive force between each other. For example, the first yoke 5700 may be a magnetic material. An attractive force may act between the first magnet 5100 and the first yoke 5700 in a direction perpendicular to the optical axis (Z-axis).

The first ball member B1 may be in contact with each of the carrier 4000 and the housing 1100 by the attractive force of the first magnet 5100 and the first yoke 5700.

An accommodation groove may be disposed on a surface in which the carrier 4000 and the housing 1100 may face each other. For example, the carrier 4000 may include a first accommodation groove, and the housing 1100 may include a second accommodation groove.

The first accommodation groove and the second accommodation groove may extend in the optical axis (Z-axis) direction. The first ball member B1 may be disposed between the first accommodation groove and the second accommodation groove.

The first ball member B1 may include a first ball group BG1 and a second ball group BG2, and each of the first ball group BG1 and the second ball group BG2 may include a plurality of balls disposed in the optical axis (Z-axis) direction.

The first ball group BG1 and the second ball group BG2 may be spaced apart from each other in a direction (e.g., X-axial direction) perpendicular to the optical axis (Z-axis). The number of balls of the first ball group BG1 and the number of balls of the second ball group BG2 may be different.

For example, the first ball group BG1 may include two or more balls disposed in the optical axis (Z-axis) direction, and the number of balls of the second ball group BG2 may be less than the number of balls included in first ball group BG1.

Under the premise that the number of balls included in the first ball group BG1 and the number of balls included in the second ball group BG2 are different, the number of balls included in each ball member may be varied. In the description below, for ease of description, the description will be based on an embodiment in which the first ball group BG1 may include three balls, and the second ball group BG2 may include two balls.

Among the three balls included in the first ball group BG1, two balls disposed on an outermost side in a direction parallel to the optical axis (Z-axis) may have the same diameter, and a ball disposed therebetween may have a diameter smaller than those of the balls disposed on the outermost side.

The two balls included in the second ball group BG2 may have the same diameter.

Meanwhile, in an embodiment, the auxiliary yoke 5710 may be disposed in a position facing the first magnet 5100. For example, the auxiliary yoke 5710 may be disposed on the substrate 7000 to face the first magnet 5100. Also, the auxiliary yoke 5710 may be disposed on an internal side of the first coil 5300.

The auxiliary yoke 5710 may be disposed closer to the first ball group BG1 than to the second ball group BG2. The auxiliary yoke 5710 may be a material that may generate attractive force to the first magnet 5100.

Accordingly, the attractive force acting between the first magnet 5100 and the first yoke 5700, and the resultant force of the attractive force acting between the first magnet 5100 and the auxiliary yoke 5710 may be disposed closer to the first ball group BG1 than to the second ball group BG2.

In an embodiment, a camera actuator 3 may detect a position of the carrier 4000 in the optical axis (Z-axis) direction.

To this end, a first position sensor 5500 may be provided. The first position sensor 5500 may be disposed on the substrate 7000 to face the first magnet 5100. The first position sensor 5500 may be a Hall sensor.

Meanwhile, the camera actuator 3 may correct shaking during filming by moving the lens module 2000 in a direction perpendicular to the optical axis (Z-axis). Thereto end, the camera actuator 3 may include a shaking driving unit 6000 moving the lens module 2000 in a direction perpendicular to the optical axis (Z-axis).

The guide frame 3000 and the lens module 2000 may be sequentially accommodated in the carrier 4000. For example, the guide frame 3000 may be disposed between the carrier 4000 and the lens module 2000. The guide frame 3000 may be a quadrangular plate shape having a hollow therein.

The guide frame 3000 and the lens module 2000 may move together in one direction perpendicular to the optical axis (Z-axis) by the driving force of the shaking driving unit 6000, and the lens module 2000 may move relative to the guide frame 3000 in another direction perpendicular to the optical axis (Z-axis).

For example, the guide frame 3000 and the lens module 2000 may move together in the first axis (X-axis) direction perpendicular to the optical axis (Z-axis). The lens module 2000 may move relative to the guide frame 3000 in the second axis (Y-axis) direction, which is perpendicular to both the optical axis (Z-axis) and the first axis (X-axis).

Also, since the base 400 of the aperture module 2 is coupled to the lens module 2000, the aperture module 2 may also move along with the lens module 2000 in the first axis (X-axis) direction and the second axis (Y-axis) direction.

The shaking driving unit 6000 may include a first sub-driving unit 6100 and a second sub-driving unit 6300. The first sub-driving unit 6100 may generate a driving force in the first axis (X-axis) direction, and the second sub-driving unit 6300 may generate a driving force in the second axis (Y-axis) direction.

The first sub-driving unit 6100 may include a second magnet 6110 and a second coil 6130. The second magnet 6110 and the second coil 6130 may be disposed to face each other in the first axis (X-axis) direction.

The second magnet 6110 may be disposed on the lens module 2000. For example, the second magnet 6110 may be mounted on one side surface of the lens holder 2200.

The second magnet 6110 may be magnetized such that one surface may have both N and S poles. For example, one surface of the second magnet 6110 may include an N pole, a neutral region and an S pole, in order, in the second axis (Y-axis) direction. The second magnet 6110 may have a shape with a length in the second axis (Y-axis) direction.

The other surface of the second magnet 6110 may be magnetized to have an opposite polarity to that of one surface of the second magnet 6110.

The second coil 6130 may be disposed to face the second magnet 6110. For example, the second coil 6130 may be disposed to face the second magnet 6110 in the first axis (X-axis) direction.

The second coil 6130 may include two coils, and each of the two coils of the second coil 6130 may have a hollow donut shape.

One of the two coils of the second coil 6130 may be disposed to face the N pole of one surface of the second magnet 6110, and the other one of the two coils of the second coil 6130 may be disposed to face an S pole of one surface of the second magnet 6110.

Due to the polarity arrangement form of the second magnet 6110, magnetic field leakage may be prevented, and accordingly, a sufficient driving force may be generated even with low power.

During image stabilization, the second magnet 6110 may be a moving member mounted on the lens module 2000, and the second coil 6130 may be a fixed member fixed to the housing 1100.

When power is applied to the second coil 6130, the lens module 2000 and the guide frame 3000 may move in the first axis (X-axis) direction by electromagnetic force between the second magnet 6110 and the second coil 6130.

The second magnet 6110 and the second coil 6130 may generate driving force in the directions facing each other (e.g., first axis (X-axis) direction).

The second sub-driving unit 6300 may include a third magnet 6310 and a third coil 6330. The third magnet 6310 and the third coil 6330 may be disposed to face each other in the second axis (Y-axis) direction.

The third magnet 6310 may be disposed on the lens module 2000. For example, the third magnet 6310 may be mounted on the other side surface of the lens holder 2200.

The third magnet 6310 may be magnetized such that one surface may have both an S pole and an N pole. For example, one surface of the third magnet 6310 may include an S pole, a neutral region and an N pole in order in the first axis (X-axis) direction. The third magnet 6310 may have a shape having a length in the first axis (X-axis) direction.

The other surface of the third magnet 6310 may be magnetized to have an opposite polarity to that of one surface of the third magnet 6310.

The third coil 6330 may be disposed to face the third magnet 6310. For example, the third coil 6330 may be disposed to face the third magnet 6310 in the second axis (Y-axis) direction.

The third coil 6330 may include two coils, and each of the two coils of the third coil 6330 may have a hollow donut shape.

One of the two coils of the third coil 6330 may be disposed to face the N pole of one surface of the third magnet 6310, and the other one of the two coils of the third coil 6330 may be disposed to face the S pole of one surface of the third magnet 6310.

Due to the polarity arrangement form of the third magnet 6310, magnetic field leakage may be prevented, and accordingly, a sufficient driving force may be generated even with low power.

The second coil 6130 and third coil 6330 may be provided on the substrate 7000. For example, the second coil 6130 and the third coil 6330 may be disposed on the substrate 7000 to face the second magnet 6110 and the third magnet 6310.

The substrate 7000 may be mounted on a side surface of housing 1100, and the second coil 6130 and the third coil 6330 may directly face the second magnet 6110 and the third magnet 6310 through an opening provided in the housing 1100.

During image stabilization, the third magnet 6310 may be a moving member mounted on the lens module 2000, and the third coil 6330 may be a fixed member fixed to the housing 1100.

When power is applied to the third coil 6330, the lens module 2000 may move in the second axis (Y-axis) direction by the electromagnetic force between the third magnet 6310 and the third coil 6330.

The third magnet 6310 and third coil 6330 may generate driving force in the directions facing each other (e.g., second axis (Y-axis) direction).

The second magnet 6110 and the third magnet 6310 may be disposed perpendicular to each other in a plane perpendicular to the optical axis (Z-axis), and the second coil 6130 and the third coil 6330 may be also disposed perpendicular to each other on a plane perpendicular to the optical axis (Z-axis).

The camera actuator 3, according to an embodiment, may include a plurality of ball members supporting the guide frame 3000 and the lens module 2000. The plurality of ball members may function to guide the movement of the guide frame 3000 and the lens module 2000 during an image stabilization process, and may also function to maintain a distance between the carrier 4000, the guide frame 3000, and the lens module 2000.

The plurality of ball members may include a second ball member B2 and a third ball member B3.

The second ball member B2 may guide movement of the guide frame 3000 and the lens module 2000 in the first axis (X-axis) direction, and the third ball member B3 may guide movement of the lens module 2000 in the second axis (Y-axis) direction.

As an example, the second ball member B2 may roll in the first axis (X-axis) direction when a driving force occurs in the first axis (X-axis) direction. Accordingly, the second ball member B2 may guide movement of the guide frame 3000 and the lens module 2000 in the first axis (X-axis) direction.

The third ball member B3 may roll in the second axis (Y-axis) direction when a driving force in the second axis (Y-axis) direction occurs. Accordingly, the third ball member B3 may guide the movement of the lens module 2000 in the second axis (Y-axis) direction.

The second ball member B2 may include a plurality of ball members disposed between the carrier 4000 and the guide frame 3000, and the third ball member B3 may include a plurality of ball members disposed between the guide frame 3000 and the lens module 2000.

For example, the second ball member B2 and the third ball member B3 may each include four ball members.

A third accommodation groove 4100 accommodating the second ball member B2 may be formed on at least one of the surfaces on which the carrier 4000 and the guide frame 3000 face each other in the optical axis (Z-axis) direction. The third accommodation groove 4100 may include a plurality of grooves corresponding to the plurality of ball members of the second ball member B2.

The second ball member B2 may be accommodated in the third accommodation groove 4100 and may be inserted between the carrier 4000 and the guide frame 3000.

While the second ball member B2 is accommodated in the third accommodation groove 4100, movement thereof in the optical axis (Z-axis) and the second axis (Y-axis) directions may be limited, and may only move in the first axis (X-axis) direction. For example, the second ball member B2 may roll only in the first axis (X-axis) direction.

To this end, a plane shape of each of the plurality of grooves of the third accommodation groove 4100 may be a quadrangular shape having a length in the first axis (X-axis) direction.

A fourth accommodation groove 3100 accommodating the third ball member B3 may be formed on at least one of the surfaces of the guide frame 3000 and the lens module 2000 (e.g., lens holder 2200) facing each other in the optical axis (Z-axis) direction. The fourth accommodation groove 3100 may include a plurality of grooves corresponding to the plurality of ball members of third ball member B3.

The third ball member B3 may be accommodated in the fourth accommodation groove 3100 and may be inserted between the guide frame 3000 and the lens module 2000.

While the third ball member B3 is accommodated in the fourth accommodation groove 3100, movement thereof in the optical axis (Z-axis) and the first axis (X-axis) directions may be limited, and may only move in the second axis (Y-axis) direction. As an example, third ball member B3 may roll only in the second axis (Y-axis) direction.

To this end, a plane shape of each of the plurality of grooves of the fourth accommodation groove 3100 may be a quadrangular shape with a length in the second axis (Y-axis) direction.

When a driving force occurs in the first axis (X-axis) direction, the guide frame 3000 and the lens module 2000 may move together in the first axis (X-axis) direction. Also, the aperture module 2 may also move in the first axis (X-axis) direction together with the lens module 2000.

Here, the second ball member B2 may roll in the first axis (X-axis). In this case, the movement of third ball member B3 may be limited.

Also, when a driving force occurs in the second axis (Y-axis) direction, the lens module 2000 may move relative to the guide frame 3000 in the second axis (Y-axis) direction. Also, the aperture module 2 may also move in the second axis (Y-axis) direction together with lens module 2000.

Here, the third ball member B3 may roll in the second axis (Y-axis). In this case, movement of the second ball member B2 may be limited.

In an embodiment, the camera actuator 3 may detect a position of the lens module 2000 in a direction perpendicular to the optical axis (Z-axis).

To this end, a second position sensor 6150 and a third position sensor 6350 may be provided. The second position sensor 6150 may be disposed on the substrate 7000 to face the second magnet 6110, and the third position sensor 6350 may be disposed on the substrate 7000 to face the third magnet 6310. The second position sensor 6150 and the third position sensor 6350 may be Hall sensors.

At least one of the second position sensor 6150 and the third position sensor 6350 may include two Hall sensors. For example, the third position sensor 6350 may include two Hall sensors disposed to face the third magnet 6310.

Whether the lens module 2000 rotates may be sensed through two Hall sensors facing the third magnet 6310. Since the third coil 6330 includes two coils facing the third magnet 6310, rotational force applied to the lens module 2000 may be canceled by controlling the third coil 6330.

Rotation of the lens module 2000 may be prevented by the configuration of the third accommodation groove and the fourth accommodation groove in which the second ball member B2 and the third ball member B3 are disposed, but due to the influence of tolerances occurring during the process of manufacturing the device, the lens module 2000 may slightly rotate.

However, the camera actuator 3, according to an embodiment, may determine whether the lens module 2000 rotates by the third coil 6330 and the third position sensor 6350 and may cancel rotational force accordingly.

Meanwhile, in the embodiments, the second yoke 4310 and the third yoke 4330 may be provided such that the carrier 4000 and the guide frame 3000 may maintain a contact state with the second ball member B2, and the guide frame 3000 and the lens module 2000 may maintain a contact state with the third ball member B3.

The second yoke 4310 and the third yoke 4330 may be fixed to the carrier 4000 and may be disposed to face the second magnet 6110 and the third magnet 6310 in the optical axis (Z-axis) direction.

Accordingly, an attractive force may occur in the optical axis (Z-axis) direction between the second yoke 4310 and the second magnet 6110, and between the third yoke 4330 and the third magnet 6310.

The lens module 2000 and the guide frame 3000 may be pressed in a direction toward the second yoke 4310 and the third yoke 4330 by the attractive force between the second yoke 4310 and the third yoke 4330 and the second magnet 6110 and third magnet 6310, such that the guide frame 3000 and the lens module 2000 may maintain a contact state with the second ball member B2 and the third ball member B3.

The second yoke 4310 and the third yoke 4330 may be materials which may generate attractive force between the second magnet 6110 and the third magnet 6310. As an example, the second yoke, 4310, and the third yoke, 4330, may be magnetic materials.

Meanwhile, the first stopper 2300 may be coupled to the carrier 4000. The first stopper 2300 may be coupled to the carrier 4000 to cover at least a portion of the upper surface of the lens module 2000. For example, the first stopper 2300 may cover at least a portion of the upper surface of the lens holder 2200.

The first stopper 2300 may prevent the guide frame 3000 and the lens module 2000 from being separated from the carrier 4000 due to external shock.

A buffer member having elastic force may be coupled to an edge portion of the first stopper 2300.

Also, the second stopper 2400 may be coupled to the housing 1100. The second stopper 2400 may include a buffer protrusion disposed in a position facing the first ball member B1 in the optical axis (Z-axis) direction.

The second stopper 2400 may prevent the carrier 4000 and the first ball member B1 from being separated due to external shock.

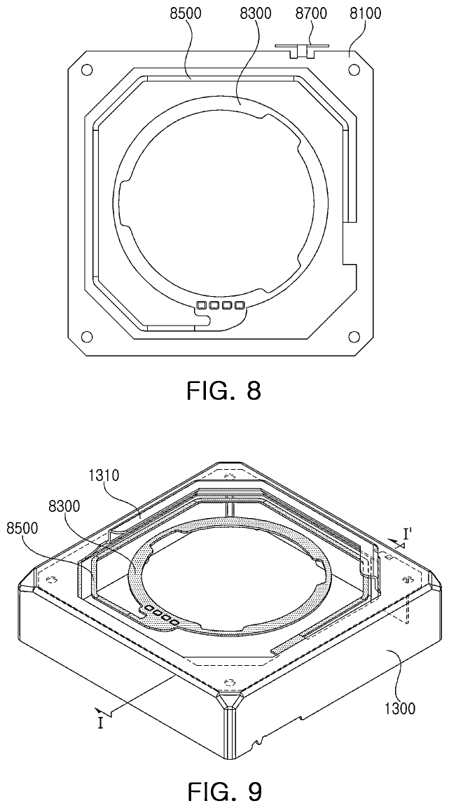

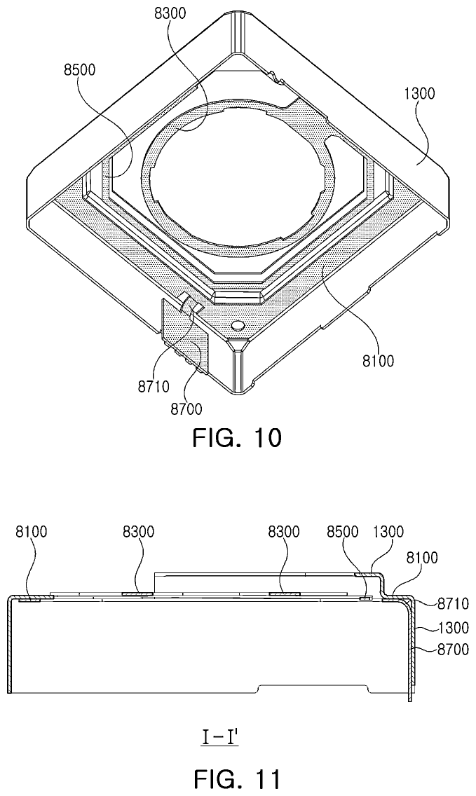

FIG. 8 is a plan diagram illustrating a connection substrate of a camera actuator. FIG. 9 is a perspective diagram illustrating a state in which a connection substrate and a case are coupled to each other. FIG. 10 is a perspective diagram in FIG. 9, viewed from below.

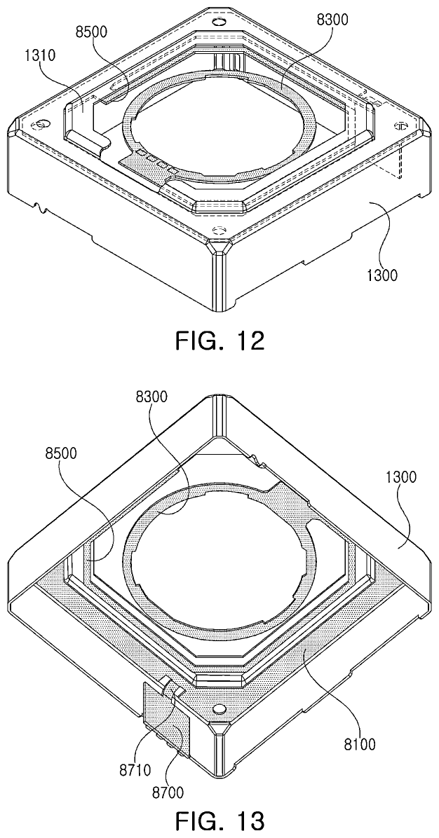

FIG. 11 is a cross-sectional diagram in FIG. 9 taken along line I-I′. FIG. 12 is a perspective diagram illustrating a state in which a connection substrate and a case are coupled to each other. FIG. 13 is a perspective diagram in FIG. 12, viewed from below.

Referring to FIGS. 3 and 8, a camera actuator 3 may include a connection substrate 8000. The connection substrate 8000 may connect an aperture substrate 540 of an aperture module 2 to a printed circuit board 9200 of an image sensor module 9000.

In other words, the aperture substrate 540 may receive power through the connection substrate 8000.

The connection substrate 8000 may include a fixing portion 8100, a moving portion 8300, and a support portion 8500. The connection substrate 8000 may be an RF PCB.

The moving portion 8300 may be disposed on an internal side of the fixing portion 8100, and the support portion 8500 may be disposed between the fixing portion 8100 and the moving portion 8300.

The fixing portion 8100 may be coupled to a case 1300 of the camera actuator 3. For example, the fixing portion 8100 may be mounted on an internal surface of case 1300. The fixing portion 8100 may be a fixed member fixed to the case 1300. The fixing portion 8100 may be a rigid PCB. Also, the fixing portion 8100 may have a quadrangular frame shape.

A connection portion 8700 extending in the optical axis (Z-axis) direction may be disposed on one side of the fixing portion 8100. The connection portion 8700 may be connected to the printed circuit board 9200 of the image sensor module 9000.

A moving portion 8300 may be coupled to an aperture module 2. For example, the moving portion 8300 may be mounted on a base 400 of the aperture module 2. The moving portion 8300 may be a moving member which may move together with the aperture module 2. The moving portion 8300 may be a rigid PCB (rigid PCB). Also, the moving portion 8300 may have a ring shape.

One portion of the moving portion 8300 may be coupled to the aperture substrate 540 of the aperture module 2. For example, one portion of the moving portion 8300 may be coupled to the first extension portion 541 of the aperture substrate 540.

A connection pad may be disposed on one side of the moving portion 8300, and an aperture substrate 540 may be coupled to the connection pad of the moving portion 8300.

For example, a connection pad may be disposed on each of the moving portion 8300 and the first extension portion 541 of the aperture substrate 540, and the connection pad of the first extension portion 541 and the connection pad of the moving portion 8300 may be soldered and bonded to each other.

In another embodiment, a connection pad may be disposed on one of the moving portion 8300 and the first extension portion 541, and a connector may be disposed on the other one. The connection pad and the connector may be connected to each other.

The support portion 8500 may be disposed between the moving portion 8300 and the fixing portion 8100, and the moving portion 8300 and the fixing portion 8100 may be connected to each other. For example, one side of the support portion 8500 may be connected to the moving portion 8300, and the other side of the support portion 8500 may be connected to the fixing portion 8100.

The support portion 8500 may be a flexible PCB. When the moving portion 8300 moves, the support portion 8500 disposed between the moving portion 8300 and the fixing portion 8100 may be bent.

The support portion 8500 may extend along a perimeter of at least a portion of the moving portion 8300. The support portion 8500 may have a single bridge shape or a plurality of bridge shapes.

The support portion 8500 may have a curved shape at least once.

Since the support portion 8500 is configured to be bendable, even when the aperture module 2 moves together with the lens module 2000, power may be stably supplied to the aperture module 2.

Meanwhile, since the aperture module 2 may move together with the lens module 2000, the magnet portion 510 and the coil portion 520 included in the aperture module 2 may also move together with the lens module 2000.

Accordingly, even when the lens module 2000 moves, a distance between the magnet portion 510 and the coil portion 520 of the aperture module 2 may be maintained, such that driving stability of the aperture module 2 may be improved.

The fixing portion 8100 may be coupled to the case 1300. For example, the fixing portion 8100 may be mounted on an upper internal surface of the case 1300.

The case 1300 may include a step portion 1310. The step portion 1310 may be disposed in a position covering at least a portion of the support portion 8500 of the connection substrate 8000 in the optical axis (Z-axis) direction.

The step portion 1310 may extend from an upper surface of the case 1300 in the optical axis (Z-axis) direction (up and down) and may have a shape curved and extending toward the optical axis (Z-axis).

The step portion 1310 (e.g., a surface curved and extended toward the optical axis (Z-axis)) and the support portion 8500 of the connection substrate 8000 may face each other in the optical axis (Z-axis) direction.

As illustrated in FIG. 9, the step portion 1310 may have a shape facing a portion of the support portion 8500 in the optical axis (Z-axis) direction. Alternatively, as illustrated in FIG. 12, the step portion 1310 may have a shape facing the entirety of the support portion 8500 in the optical axis (Z-axis) direction.

When the aperture module 2 moves together with the lens module 2000, the support portion 8500 of the connection substrate 8000 may be bent. In this case, the step portion 1310 may limit a range in which the support portion 8500 of the connection substrate 8000 is bent. Accordingly, the support portion 8500 of the connection substrate 8000 may be prevented from being excessively deformed.

The connection substrate 8000 may include a connection portion 8700 and a curved portion 8710. The connection portion 8700 may be connected to the fixing portion 8100 by a curved portion 8710 and may extend in the optical axis (Z-axis) direction. The connection portion 8700 of the connection substrate 8000 may be mounted on an internal surface of case 1300. Also, an end of the connection portion 8700 may be connected to the printed circuit board 9200 of the image sensor module 9000.

The curved portion 8710 may be configured to connect the connection portion 8700 to the fixing portion 8100, and at least a portion thereof may have a curvature. The curved portion 8710 may be spaced apart from the case 1300.

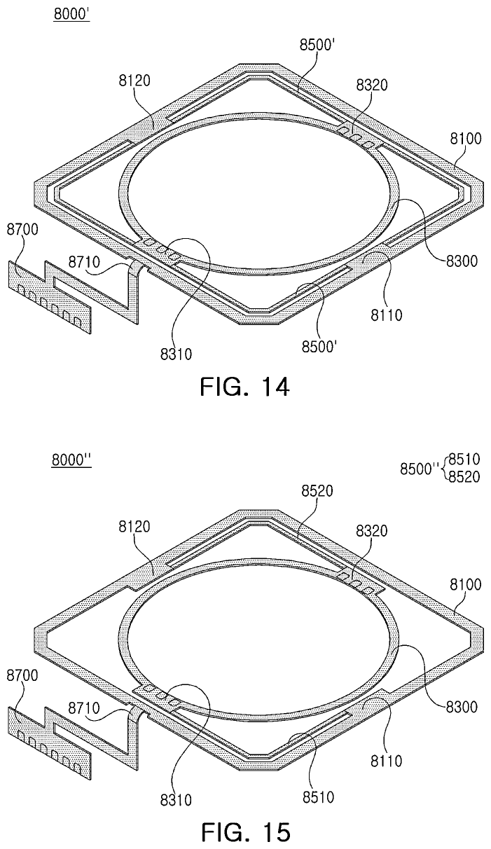

FIGS. 14 to 16 are diagrams illustrating modified examples of a connection substrate.

Referring to FIG. 14, a connection substrate 8000′ may include a fixing portion 8100, a moving portion 8300, and a support portion 8500′. ‘the connection substrate 8000′ may be an RF PCB.

The moving portion 8300 may be disposed on an internal side of the fixing portion 8100, and the support portion 8500′ may be disposed between the fixing portion 8100 and the moving portion 8300.

Connection pads may be disposed on one side and the other side of the moving portion 8300, respectively, and an aperture substrate 540 may be coupled to the connection pad of the moving portion 8300.

The support portion 8500′ may be disposed between the moving portion 8300 and the fixing portion 8100, and may connect the moving portion 8300 to the fixing portion 8100. The support portion 8500′ may be a flexible PCB. When the moving portion 8300 moves, the support portion 8500′ disposed between the moving portion 8300 and the fixing portion 8100 may be bent.

The support portion 8500′ may extend along a perimeter of the internal side of the fixing portion 8100. The support portion 8500′ may have a single bridge shape or a plurality of bridge shapes.

One portion of the support portion 8500′ may be connected to the moving portion 8300, and the other portion of the support portion 8500 may be connected to the fixing portion 8100.

The fixing portion 8100 may include a first coupling portion 8110 and a second coupling portion 8120, and the moving portion 8300 may include a third coupling portion 8310 and a fourth coupling portion 8320.

The first coupling portion 8110 and the second coupling portion 8120 may be disposed on opposite sides of each other with respect to the optical axis (Z-axis), and the third coupling portion 8310 and the fourth coupling portion 8320 may be disposed on opposite sides with respect to the optical axis (Z-axis).

The connection pads may be disposed in the third coupling portion 8310 and the fourth coupling portion 8320, respectively.

The first coupling portion 8110 and the second coupling portion 8120 may have a shape protruding from the fixing portion 8100 toward the moving portion 8300, and the third coupling portion 8310 and the fourth coupling portion 8320 may have a shape protruding from the moving portion 8300 toward the fixing portion 8100.

A conceptual line connecting the first coupling portion 8110 to the second coupling portion 8120 and a conceptual line connecting the third coupling portion 8310 to the fourth coupling portion 8320 may be perpendicular to each other.

The support portion 8500′ may be connected to the fixing portion 8100 through the first coupling portion 8110 and the second coupling portion 8120. Also, the support portion 8500′ may be connected to the moving portion 8300 through the third coupling portion 8310 and the fourth coupling portion 8320.

For example, the first coupling portion 8110 and the second coupling portion 8120 may protrude and extend from the fixing portion 8100 and may be spaced apart from the moving portion 8300. Also, the third coupling portion 8310 and the fourth coupling portion 8320 may protrude and extend from the moving portion 8300 and may be spaced apart from the fixing portion 8100.

The support portion 8500′ may extend along a perimeter of the internal side of the fixing portion 8100 and may be connected to the first coupling portion 8110 to the fourth coupling portion 8320.

For example, the support portion 8500′ may have a shape connecting the first coupling portion 8110 to the third coupling portion 8310, connecting the second coupling portion 8120 to the third coupling portion 8310, connecting the first coupling portion 8110 to the fourth coupling portion 8320, and connecting the second coupling portion 8120 to the fourth coupling portion 8320.

In an embodiment, the first coupling portion 8110 and the second coupling portion 8120 may be spaced apart from each other in the second axis (Y-axis) direction. Also, the third coupling portion 8310 and the fourth coupling portion 8320 may be spaced apart from each other in the first axis (X-axis) direction.

Accordingly, the moving portion 8300 may move while being elastically supported by the support portion 8500′.

Referring to FIG. 15, the support portion 8500″ of the connection substrate 8000″ may include a first support portion 8510 and a second support portion 8520.

The first support portion 8510 may extend between the first coupling portion 8110 and the third coupling portion 8310. For example, one side of the first support portion 8510 may be connected to the first coupling portion 8110, and the other side of the first support portion 8510 may be connected to the third coupling portion 8310.

The second support portion 8520 may extend between the second coupling portion 8120 and the fourth coupling portion 8320. For example, one side of the second support portion 8520 may be connected to the second coupling portion 8120, and the other side of the second support portion 8520 may be connected to the fourth coupling portion 8320.

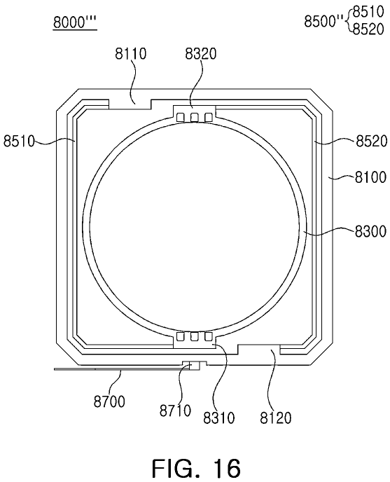

Referring to FIG. 16, the first coupling portion 8110 of the connection substrate 8000″ may be disposed adjacent to the fourth coupling portion 8320. Also, the second coupling portion 8120 may be disposed adjacent to the third coupling portion 8310.

For example, at least a portion of the first coupling portion 8110 and the fourth coupling portion 8320 may overlap in the first axis (X-axis) direction or the second axis (Y-axis) direction.

Also, at least a portion of the second coupling portion 8120 and the third coupling portion 8310 may overlap in the first axis (X-axis) direction or the second axis (Y-axis) direction.

The first support portion 8510 may extend between the first coupling portion 8110 and the third coupling portion 8310. For example, one side of the first support portion 8510 may be connected to the first coupling portion 8110, and the other side of the first support portion 8510 may be connected to the third coupling portion 8310.

The second support portion 8520 may extend between the second coupling portion 8120 and the fourth coupling portion 8320. For example, one side of the second support portion 8520 may be connected to the second coupling portion 8120, and the other side of the second support portion 8520 may be connected to the fourth coupling portion 8320.

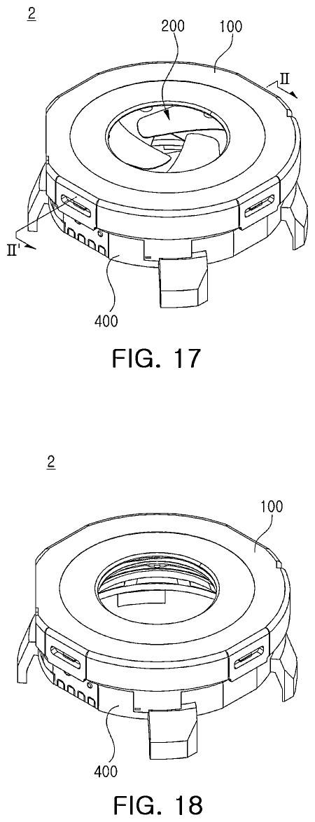

FIG. 17 is a perspective diagram illustrating a state in which an aperture module has a relatively narrow aperture according to an embodiment. FIG. 18 is a perspective diagram illustrating a state in which an aperture module has a relatively large aperture according to an embodiment.

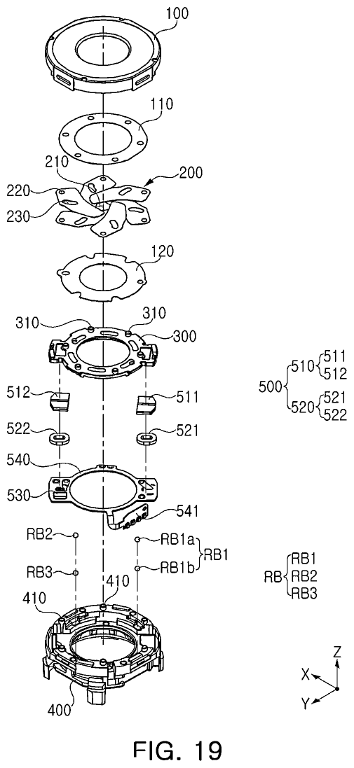

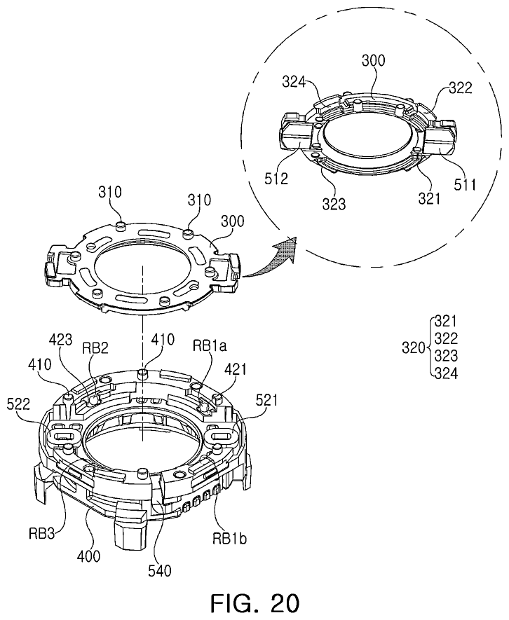

FIG. 19 is an exploded perspective diagram illustrating an aperture module according to an embodiment. FIG. 20 is an exploded perspective diagram illustrating an example in which an aperture driving unit is disposed on a base and a rotating body.

Referring to FIGS. 17 to 20, an aperture module 2, according to an embodiment, may include a base 400, a rotating body 300, a plurality of blades 200 and an aperture driving unit 500.

The base 400 may be coupled to a camera actuator 3. For example, the base 400 may be coupled to the lens module 2000 of the camera actuator 3. In this case, the aperture module 2 may move together with the lens module 2000 as the lens module 2000 moves.

The rotating body 300 may rotate relative to the base 400. For example, the rotating body 300 may be spaced apart from the base 400 in the optical axis (Z-axis) direction and may rotate relative to the base 400. As the rotating body 300 rotates, the size of an aperture 210 of the aperture module 2 may change.

The plurality of blades 200 may form the aperture 210. A portion of each blade may be disposed to overlap other blades in the optical axis (Z-axis) direction. For example, one set of the plurality of blades (e.g., three blades) and another set of the plurality of blades (e.g., three blades) may be sequentially disposed in the optical axis (Z-axis) direction. Here, a portion of one blade may be disposed to overlap the other two blades in the optical axis (Z-axis) direction.

In the embodiment, a total of six blades may be provided, three blades may form a set, and 2 sets of blades may be stacked in two layers, but the number of the plurality of blades 200 is not limited thereto.

The aperture 210 may be defined by the surfaces of each blade facing toward the optical axis (Z-axis). The position of each blade may be varied by the aperture driving unit 500. Accordingly, the size of the aperture 210 may change depending on the position of each blade.

For example, as illustrated in FIGS. 17 and 18, the size of the aperture 210 may be reduced or increased by rotation of each blade.

The plurality of blades 200 may be coupled to the base 400 and the rotating body 300. Since each of the blades may have the same shape, a single blade will be described below.

The blade may include a through-hole 220. For example, the blade may have a through-hole 220 on an external side end, and the through-hole 220 may have a shape penetrating a blade in the optical axis (Z-axis) direction.

A through-hole 220 of the blade may be coupled to the base 400. For example, a protrusion 410 protruding in the optical axis (Z-axis) direction may be disposed on the base 400, and the protrusion 410 may be coupled to the through-hole 220 of the blade. Similarly to the plurality of blades 200, a plurality of the protrusions 410 may be provided.

The protrusion 410 may form a rotation shaft of the blade. The protrusion 410 and the through-hole 220 may have corresponding sizes.

Also, the blade may include a guide hole 230. For example, the blade may have a guide hole 230 disposed in a position spaced apart from the through-hole 220.

The guide hole 230 of the blade may be coupled to the rotating body 300. For example, a guide protrusion 310 protruding in the optical axis (Z-axis) direction may be disposed on the rotating body 300, and the guide protrusion 310 may be coupled to the guide hole 230 of the blade. Similarly to the plurality of blades 200, a plurality of guide protrusions 310 may be provided.

The guide hole 230 may have a size greater than the guide protrusion 310. For example, the width of the guide hole 230 may correspond to the diameter of the guide protrusion 310, and the length of the guide hole 230 may be greater than the diameter of the guide protrusion 310.

A shape of the guide hole 230 is not limited thereto. For example, when the structure may move a position of the blade in conjunction with the movement of the rotating body 300, the shape of the guide hole 230 may be varied.

Accordingly, as the rotating body 300 rotates, the guide protrusion 310 may move in the guide hole 230, and accordingly, the blade may rotate using the protrusion 410 of the base 400 as a rotation shaft.

Aperture module 2, according to an embodiment, may further include a cover 100. The cover 100 may be coupled to the base 400. A plurality of blades 200 and the rotating body 300 may be disposed in a space between the cover 100 and the base 400.

A first spacer 110 may be disposed between the plurality of blades 200 and the cover 100. For example, the first spacer 110 may be coupled to the rotating body 300 and may be disposed between the plurality of blades 200 and the cover 100. The first spacer 110 may cover at least a portion of an upper surface of the plurality of blades 200. The surface of the first spacer 110 may be coated black.

The first spacer 110 may have a through-hole through which light passes, and the size of the through-hole of the first spacer 110 may be greater than the maximum size of the aperture 210 formed by the plurality of blades 200.

A second spacer 120 may be disposed between the rotating body 300 and the plurality of blades 200. For example, the second spacer 120 may be coupled to the rotating body 300 and may be disposed between the rotating body 300 and the plurality of blades 200. The second spacer 120 may cover at least a portion of a lower surface of the plurality of blades 200. The surface of the second spacer 120 may be coated black.

The second spacer 120 may have a through-hole through which light passes, and the size of the through-hole of the second spacer 120 may be greater than the maximum size of the aperture 210 formed by the plurality of blades 200. Also, the size of the through-hole of the second spacer 120 may be smaller than the size of the through-hole of the first spacer 110.

The aperture driving unit 500 may move the rotating body 300 to change the size of the aperture 210. For example, the aperture driving unit 500 may rotate the rotating body 300 by generating a driving force.

As the rotating body 300 rotates, the guide protrusion 310 of the rotating body 300 may move in the guide hole 230 of the plurality of blades 200, and accordingly, the plurality of blades 200 may rotate using the protrusion 410 of the base 400 as a rotation shaft such that the size of the aperture 210 may change.

The aperture driving unit 500 may include a magnet portion 510 and a coil portion 520. The magnet portion 510 and the coil portion 520 may be disposed to face each other in the optical axis (Z-axis) direction.

The magnet portion 510 may be disposed on one of the rotating body 300 and the base 400, and the coil portion 520 may be disposed on the other one.

For example, the magnet portion 510 may be mounted on the rotating body 300. As an example, the magnet portion 510 may be mounted on a lower surface of the rotating body 300.

The magnet portion 510 may include a plurality of aperture magnets spaced apart from each other. As an example, the magnet portion 510 may include a first aperture magnet 511 and a second aperture magnet 512 disposed on opposite sides with respect to the optical axis (Z-axis).

Each of the first and second aperture magnets 511 and 512 may be magnetized such that one surface (e.g., the surface facing the coil portion 520) may have both N and S poles. As an example, an N pole, a neutral region, and an S pole may be provided in order on one surface of the first and second aperture magnet 512 facing the coil portion 520 in a direction perpendicular to the optical axis (Z-axis) (e.g., a rotation direction of the rotating body 300).

The coil portion 520 may be disposed to face the magnet portion 510. For example, the coil portion 520 may be disposed to face the magnet portion 510 in the optical axis (Z-axis) direction.

The coil portion 520 may be disposed on the aperture substrate 540, and the aperture substrate 540 may be mounted on the base 400 such that the magnet portion 510 and the coil portion 520 may face each other in the optical axis (Z-axis) direction. As an example, the coil portion 520 may be disposed on one surface of the aperture substrate 540. The aperture substrate 540 may be mounted on the upper surface of base 400.

Also, the aperture substrate 540 may include a first extension portion 541 extending from an upper surface side of the base 400 to a side surface of the base 400. The first extension portion 541 may be connected to a connection substrate 8000, which will be described later.

The coil portion 520 may include a plurality of aperture coils. As an example, the coil portion 520 may include a first aperture coil 521 and a second aperture coil 522 disposed on opposite sides with respect to the optical axis (Z-axis).

The magnet portion 510 may be a moving member mounted on the rotating body 300 and rotating with the rotating body 300, and the coil portion 520 may be a fixed member fixed to the base 400.

In another embodiment, the magnet portion 510 and the coil portion 520 may be disposed conversely and differently from the above example. In this case, since the coil portion 520 and the aperture substrate 540 are mounted on the rotating body 300 and rotate together with the rotating body 300, at least a portion of the aperture substrate 540 may be configured to be flexible.

When power is applied to the coil portion 520, the rotating body 300 may rotate by electromagnetic force between the magnet portion 510 and the coil portion 520.

In the embodiment, the aperture driving unit 500, for example, the magnet portion 510 may rotate to rotate the rotating body 300.

When the magnet is linearly moved and linear movement of the magnet is changed to rotational movement of the rotating body, the rotating body may rotate by an external force when power is not applied, and the size of the aperture may be changed, which may be problematic.

However, in the embodiment, a weight center of the aperture driving unit 500, for example, the magnet portion 510, may be disposed on an internal side of the rotation radius of the rotating body 300, such that the rotating body 300 may not rotate even when an external force is applied.

A rolling portion RB may be disposed between the base 400 and the rotating body 300. For example, the rolling portion RB may be disposed between the base 400 and the rotating body 300 such that friction may be reduced when the rotating body 300 rotates.

The rolling portion RB may include a plurality of rolling balls spaced apart from each other in a circumferential direction of the rotating body 300. When the rotating body 300 rotates, the plurality of rolling balls may roll in a rotation direction of the rotating body 300. The rolling portion RB may include three or more rolling balls. In the embodiment, the rolling portion RB may include four rolling balls, but when three or more rolling balls are included, the number of the plurality of rolling balls is not limited.

The pulling yoke portion 550 may be disposed on the base 400. The pulling yoke portion 550 may be disposed in a position facing the magnet portion 510 in the optical axis (Z-axis) direction.

The pulling yoke portion 550 may be integrally coupled to the base 400 by insert injection. In this case, the pulling yoke portion 550 may be manufactured to be integrated with the base 400 by injecting a resin material into a mold while the pulling yoke portion 550 is fixed in the mold.

The pulling yoke portion 550 and the magnet portion 510 may generate attractive force between each other. For example, the pulling yoke portion 550 may be a magnetic material. An attractive force may act in the optical axis (Z-axis) direction between the magnet portion 510 and the pulling yoke portion 550.

The rolling portion RB may be in contact with the base 400 and the rotating body 300, respectively, by attractive force of the magnet portion 510 and the pulling yoke portion 550.

The pulling yoke portion 550 may include a first pulling yoke 551 and a second pulling yoke 552. The first pulling yoke 551 may face the first aperture magnet 511 in the optical axis (Z-axis) direction, and the second pulling yoke 552 may face the second aperture magnet 512 in the optical axis (Z-axis) direction.

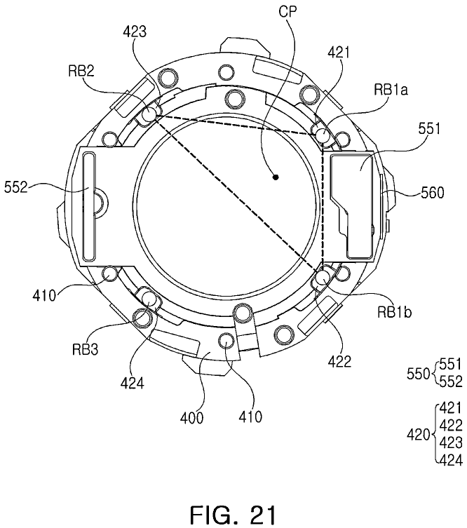

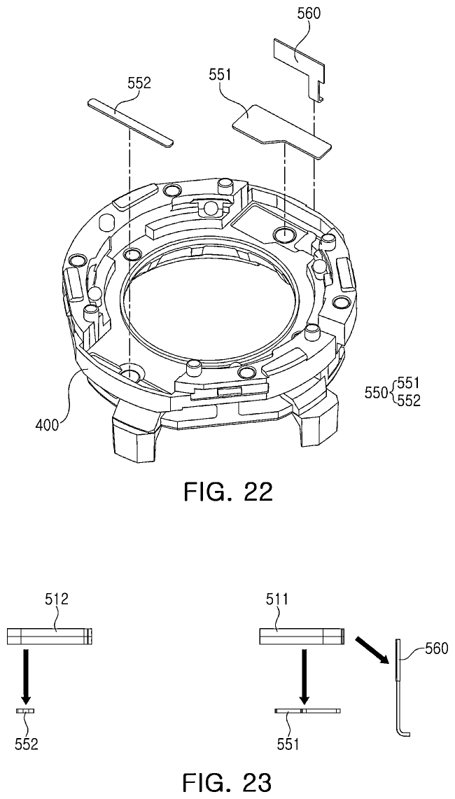

FIG. 21 is a plan diagram illustrating a state in which a rolling portion is disposed on a base. FIG. 22 is a perspective diagram illustrating a state in which a pulling yoke portion and an auxiliary yoke are separated from a base. FIG. 23 is a diagram illustrating an arrangement form of a magnet portion, a pulling yoke portion and an auxiliary yoke.

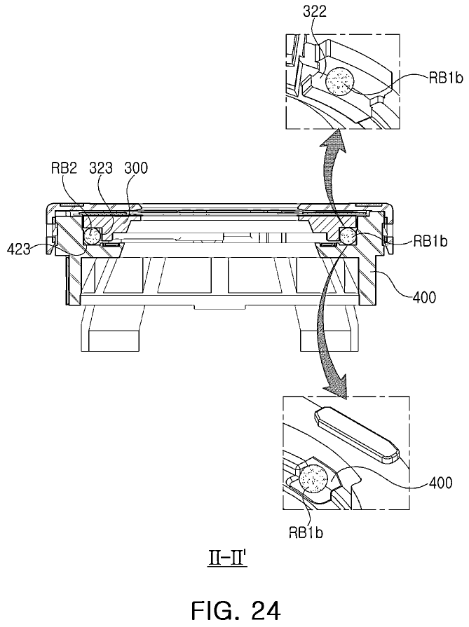

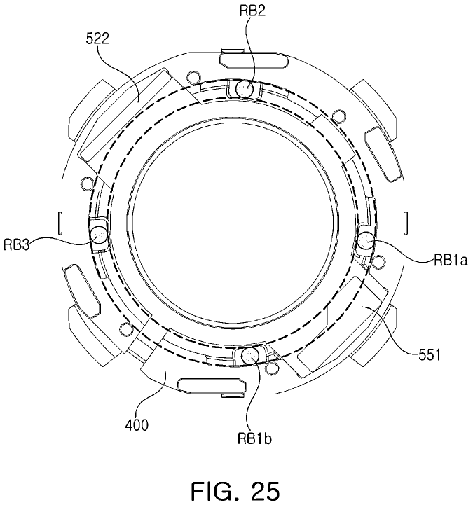

FIG. 24 is a cross-sectional diagram in FIG. 17 taken along line II-II′. FIG. 25 is a plan diagram illustrating a guide groove in which a rolling portion is disposed.

Referring to FIG. 21, the rolling portion RB may include a first rolling member RB1 and a second rolling member RB2, and may further include a third rolling member RB3. The first to third rolling members RB1, RB2, and RB3 may be spaced apart from the base 400 in the circumferential direction.

Each of the first to third rolling members RB1, RB2, and RB3 may include one or more rolling balls.

The number of rolling balls included in the first rolling member RB1 may be greater than the number of rolling balls included in the second rolling member RB2. Also, the number of rolling balls included in the first rolling member RB1 may be greater than the number of rolling balls included in the third rolling member RB3.

In an embodiment, the first rolling member RB1 may include at least two rolling balls spaced apart from of the base 400 in the circumferential direction. For example, the first rolling member RB1 may include a first rolling ball RB1a and a second rolling ball RB1b. The second rolling member RB2 may include a rolling ball (e.g., third rolling ball), and the third rolling member RB3 may include at least one rolling ball (e.g., fourth rolling ball).

The first rolling member RB1 may be disposed closer to the first aperture magnet 511 than to the second aperture magnet 512. The second rolling member RB2 may be disposed closer to the second aperture magnet 512 than to the first aperture magnet 511. A relative position of the third rolling member RB3 with respect to the magnet portion 510 is not limited.

A guide groove portion may be disposed on a surface on which the base 400 and the rotating body 300 may face each other. For example, the first guide groove portion 420 may be disposed on the base 400, and the second guide groove portion 320 may be disposed on the rotating body 300.

The rolling portion RB may be disposed between the first guide groove portion 420 and the second guide groove portion 320.

The first guide groove portion 420 may include a 1-1 guide groove 421, a 1-2 guide groove 422, a 1-3 guide groove 423 and a 1-4 guide groove 424. The 1-1 guide groove 421 to the 1-4 guide groove 424 may be spaced apart from in the circumferential direction of the base 400.

Each of the 1-1 guide groove 421 to the 1-4 guide groove 424 may include a bottom surface formed on one surface (e.g., upper surface) of base 400 and a side surface extending from a bottom surface in the optical axis (Z-axis) direction. For example, each of the 1-1 guide groove 421 to the 1-4 guide groove 424 may have a cross-section having an “ [symbol] ” shape.

The second guide groove portion 320 may include a 2-1 guide groove 321, a 2-2 guide groove 322, a 2-3 guide groove 323 and a 2-4 guide groove 324. The 2-1 guide groove 321 to the 2-4 guide groove 324 may be spaced apart from in a circumferential direction of the rotating body 300.

Each of the 2-1 guide groove 321 to the 2-4 guide groove 324 may include a bottom surface formed on one surface (e.g., lower surface) of the rotating body 300 and a side surface extending from a bottom surface in the optical axis (Z-axis) direction. For example, each of the 2-1 guide groove 321 to the 2-4 guide groove 324 may have a cross-section having “ [symbol] ” shape.

The 1-1 guide groove 421 and the 2-1 guide groove 321 may be disposed to face each other, and one of the two rolling balls of the first rolling member RB1 (e.g., first rolling ball RB1a) may be disposed in a space between the guide groove 421 and the 2-1 guide groove 321.

The bottom surface of the 1-1 guide groove 421 and the bottom surface of the 2-1 guide groove 321 may face each other in the optical axis (Z-axis) direction, and a side surface of the 1-1 guide groove 421 and a side surface of 2-1 guide groove 321 may face each other in a direction perpendicular to the optical axis (Z-axis).

Also, the 1-2 guide groove 422 and the 2-2 guide groove 322 may be disposed to face each other, and the other of the two rolling balls of the first rolling member RB1 (e.g., second rolling ball RB1b) may be disposed in a space between the 1-2 guide groove 422 and the 2-2 guide groove 322.

The bottom surface of the 1-2 guide groove 422 and the bottom surface of the 2-2 guide groove 322 may face each other in the optical axis (Z-axis) direction, and the side surface of the 1-2 guide groove 422 and the side surface of the 2-2 guide groove 322 may face each other in a direction perpendicular to the optical axis (Z-axis).

The first rolling ball RB1a of the first rolling member RB1 may be in two-point contact with each of the 1-1 guide groove 421 and the 2-1 guide groove 321.

For example, the first rolling ball RB1a may be in two-point contact with the 1-1 guide groove 421 and in two-point contact with the 2-1 guide groove 321. As an example, the first rolling ball RB1a may be in contact with the bottom surface and the side surface of the 1-1 guide groove 421, and may be in contact with the bottom surface and the side surface of the 2-1 guide groove 321.

The contact point of the bottom surface of the 1-1 guide groove 421 and the contact point of the bottom surface of the 2-1 guide groove 321 may face each other in the optical axis (Z-axis) direction, and the contact point of the side surface of the 1-1 guide groove 421 and the contact point of the side surface of the 2-1 guide groove 321 may face in a direction perpendicular to the optical axis (Z-axis).

For example, a conceptual line connecting the contact point of the bottom surface of the 1-1 guide groove 421 to the contact point of the bottom surface of the 2-1 guide groove 321, and a conceptual line connecting the contact point of the side surface of 1-1 guide groove 421 to the contact point of the side surface of 2-1 guide groove 321 may have a “+” shape.

The second rolling ball RB1b of the first rolling member RB1 may be in two-point contact with each of the 1-2 guide groove 422 and the 2-2 guide groove 322.

For example, the second rolling ball RB1b may be in two-point contact with the 1-2 guide groove 422, and may be in two-point contact with the 2-2 guide groove 322. As an example, the second rolling ball RB1b may be in contact with the bottom surface and the side surface of the 1-2 guide groove 422, and may be in contact with the bottom surface and the side surface of the 2-2 guide groove 322.

The contact point of the bottom surface of the 1-2 guide groove 422 and the contact point of the bottom surface of the 2-2 guide groove 322 may face each other in the optical axis (Z-axis) direction, and the contact point of the side surface of the 1-2 guide groove 422 and the contact point of the side surface of the 2-2 guide groove 322 may face in a direction perpendicular to the optical axis (Z-axis).

For example, a conceptual line connecting the contact point of the bottom surface of the 1-2 guide groove 422 to the contact point of the bottom surface of the 2-2 guide groove 322, and a conceptual line connecting the contact point of the side surface of the 1-2 guide groove 422 to the contact point of the side surface of the 2-2 guide groove 322 may have a “+” shape.

The first rolling member RB1, the 1-1 guide groove 421, the 1-2 guide groove 422, the 2-1 guide groove 321 and the 2-2 guide groove 322 may function as a main guide for guiding rotation of the rotating body 300.

The 1-3 guide groove 423 and the 2-3 guide groove 323 may be disposed to face each other, and the second rolling member RB2 may be disposed in a space between the 1-3 guide groove 423 and the 2-3 guide groove 323.

The bottom surface of the 1-3 guide groove 423 and the bottom surface of the 2-3 guide groove 323 may face each other in the optical axis (Z-axis) direction, and the side surface of the 1-3 guide groove 423 and the side surface of the 2-3 guide groove 323 may face each other in a direction perpendicular to the optical axis (Z-axis).

The second rolling member RB2 may be in contact with the 1-3 guide groove 423 and the 2-3 guide groove 323. The number of contact points between the second rolling member RB2, and the 1-3 guide groove 423 and the 2-3 guide groove 323 may be two or three.

For example, when the number of contact points between the second rolling member RB2 and the 1-3 guide groove 423 and the 2-3 guide groove 323 is two, the second rolling member RB2 may be in contact with the bottom surface of the 1-3 guide groove 423 and the bottom surface of the 2-3 guide groove 323.

When the number of contact points between the second rolling member RB2 and the 1-3 guide groove 423 and the 2-3 guide groove 323 is three, the second rolling member RB2 may be in contact with the bottom surface of the 1-3 guide groove 423 and the bottom surface of the 2-3 guide groove 323, and may be in contact with one of the side surface of the 1-3guide groove 423 or the side surface of the 2-3 guide groove 323.

A distance between surfaces (e.g., the side surface of the 1-3 guide groove 423 and the side surface of the 2-3 guide groove 323) of the 1-3 guide groove 423 and the 2-3 guide groove 323 facing in a direction perpendicular to the optical axis (Z-axis) direction may be greater than the diameter of the second rolling member RB2.

The second rolling member RB2, the 1-3 guide groove 423 and the 2-3 guide groove 323 may function as an auxiliary guide supporting rotation of the rotating body 300.

When viewed in the optical axis (Z-axis) direction, the rotating body 300 may be in three-point contact with the base 400 by the first rolling member RB1 and the second rolling member RB2 (e.g., a triangular support region).

The 1-4 guide groove 424 and the 2-4 guide groove 324 may be disposed to face each other, and the third rolling member RB3 may be disposed in a space between the 1-4 guide groove 424 and the 2-4 guide groove 324.

The bottom surface of the 1-4 guide groove 424 and the bottom surface of the 2-4 guide groove 324 may face each other in the optical axis (Z-axis) direction, and the side surface of the 1-4 guide groove 424 and the side surface of the 2-4 guide groove 324 may face each other in a direction perpendicular to the optical axis (Z-axis).

The third rolling member RB3 may be in contact with at least one of the 1-4 guide groove 424 and the 2-4 guide groove 324. The number of contact points between the third rolling member RB3 and the 1-4 guide groove 424 and the 2-4 guide groove 324 may be one or two.

For example, when the number of contact points between the third rolling member RB3 and the 1-4 guide groove 424 and the 2-4 guide groove 324 is one, the third rolling member RB3 may be in contact with the bottom surface of the 1-4 guide groove 424 or the bottom surface of the 2-4 guide groove 324.

When the number of contact points between the third rolling member RB3 and the 1-4 guide groove 424 and the 2-4 guide groove 324 is two, the third rolling member RB3 may be in one-point contact with one of the bottom surfaces of the 1-4 guide groove 424 and the bottom surface of the 2-4 guide groove 324, and be in one-point contact with one of the side surface of the 1-4 guide groove 424 or the side surface of the 2-4 guide groove 324.

In an embodiment, a distance between the bottom surface of the 1-4 guide groove 424 and the bottom surface of the 2-4 guide groove 324 in the optical axis (Z-axis) direction may be greater than a distance between the bottom surface of the 1-1 guide groove 421 and the bottom surface of the 2-1 guide groove 321 in the optical axis (Z-axis) direction.

In an embodiment, a distance between the bottom surface of the 1-4 guide groove 424 and the bottom surface of the 2-4 guide groove 324 in the optical axis (Z-axis) direction may be greater than the diameter of the rolling ball of the third rolling member RB3.

In an embodiment, the diameter of the rolling ball of the third rolling member RB3 may be smaller than the diameter of the rolling balls of the first rolling member RB1 and the diameter of the rolling ball of the second rolling member RB2.

The third rolling member RB3 may function to prevent the rotating body 300 from being tilted relative to the base 400 during external impact. That is, by preventing the rotating body 300 from being tilted with respect to the base 400 during external impact, the rolling portion RB may be prevented from being separated from the base 400 and the rotating body 300.

However, the third rolling member RB3 may be an optional component, and when the third rolling member RB3 is not provided, the rotating body 300 may be prevented from being tilted by adjusting the positions of the first rolling member RB1 and the second rolling member RB2.

When viewed in the optical axis (Z-axis) direction, the rotating body 300 may be in three-point contact with the base 400 by the first rolling member RB1 and the second rolling member RB2.

In this case, for the rotating body 300 to stably rotate, the central point CP of attractive force acting between the magnet portion 510 and the pulling yoke portion 550 may need to be disposed in a support region connecting the contact points of the first rolling member RB1 and the base 400 (or rotating body 300) and the contact points of the second rolling member RB2 and the base 400 (or rotating body 300).

Also, since a width of the support region increases toward the first rolling member RB1, it may be desired to dispose the central point CP of attractive force toward the first rolling member RB1.

To this end, by configuring sizes of the first pulling yoke 551 and the second pulling yoke 552 differently, a central point CP of attractive force may be disposed closer to the first rolling member RB1.

In an embodiment, the area of the first pulling yoke 551 facing the first aperture magnet 511 may be greater than the area of the second pulling yoke 552 facing the second aperture magnet 512.

In other words, by configuring the size of the first pulling yoke 551 to be greater than the size of the second pulling yoke 552, the central point CP of attractive force may be disposed closer to the first rolling member RB1.

As another example, by configuring the size of the first aperture magnet 511 to be greater than the size of the second aperture magnet 512, the central point CP of the attractive force may be disposed closer to the first rolling member RB1.

As another example, by configuring a distance between the first aperture magnet 511 and the first pulling yoke 551 in the optical axis (Z-axis) direction to be less than the distance between the second aperture magnet 512 and the second pulling yoke 552 in the optical axis (Z-axis) direction, the central point CP of attractive force may be disposed closer to the first rolling member RB1.

An area of a portion of the first pulling yoke 551 may be configured to be greater than an area of the other portion. For example, the first pulling yoke 551 may have a quadrangular shape and a protrusion protruding from a long side of the quadrangular shape. Accordingly, a relative position of the first aperture magnet 511 with respect to the first pulling yoke 551 may be maintained to be constant when power is not applied to the aperture driving unit 500.

In an embodiment, the first pulling yoke 551 may have an asymmetric shape with respect to the center of the first pulling yoke 551. For example, an area may be larger than the other area with respect to a conceptual line passing through the optical axis (Z-axis) and crossing the center of the first pulling yoke 551.

As another example, the width of the first pulling yoke 551 may be configured to increase from an end of one side in the length direction to an end of the other side in the length direction.

As another example, the first pulling yoke 551 may be provided as two yokes disposed adjacent to each other. In this case, the size of one of the yokes may be greater than the size of the other yokes.

Meanwhile, referring to FIG. 22, the aperture module 2, according to an embodiment, may further include an auxiliary yoke 560.

The auxiliary yoke 560 may be disposed closer to the first aperture magnet 511 than to the second aperture magnet 512.

When viewed in the optical axis (Z-axis) direction, the first aperture magnet 511, the first pulling yoke 551 and the auxiliary yoke 560 may be disposed in a space between the first rolling ball RB1a and the second rolling ball RB1b.

The auxiliary yoke 560 may be disposed on an internal side surface extending in the optical axis (Z-axis) direction among surfaces of the base 400. For example, the auxiliary yoke 560 may be disposed such that at least a portion may face the first aperture magnet 511 in a direction perpendicular to the optical axis (Z-axis). The auxiliary yoke 560 may be a magnetic material.

The auxiliary yoke 560 may be integrally coupled to the base 400 by insert injection. In this case, the auxiliary yoke 560 may be manufactured to be integrated into the base 400 by injecting resin material into a mold while the auxiliary yoke 560 is fixed in the mold.

In an embodiment, a position of an upper end of the auxiliary yoke 560 in the optical axis (Z-axis) direction may be disposed between an upper surface and a lower surface of the first aperture magnet 511.

An attractive force may act in the optical axis (Z-axis) direction by the first aperture magnet 511 and the first pulling yoke 551, and attractive force may act in a direction (e.g., a direction perpendicular to the optical axis (Z-axis) or a direction inclined downward while intersecting the optical axis (Z-axis)) intersecting the optical axis (Z-axis) by the first aperture magnet 511 and the auxiliary yoke 560.

In other words, an attractive force may act on the first aperture magnet 511 in at least two directions intersecting each other.

Due to the attractive force acting between the first aperture magnet 511 and the first pulling yoke 551, the rotating body 300, including the first aperture magnet 511 mounted thereon, may move toward the base 400 including the first pulling yoke 551 mounted thereon in the optical axis (Z-axis) direction.

Accordingly, due to attractive force acting between the first aperture magnet 511 and the first pulling yoke 551, the first rolling ball RB1a may be in contact with the bottom surface of the 1-1 guide groove 421 and the bottom surface of the 2-1 guide groove 321.

Due to the attractive force acting between the first aperture magnet 511 and the first pulling yoke 551, the second rolling ball RB1b may be in contact with the bottom surface of the 1-2 guide groove 422 and the bottom surface of the 2-2 guide groove 322.

Due to attractive force acting between the first aperture magnet 511 and the auxiliary yoke 560, the rotating body 300 including the first aperture magnet 511 thereon may be pulled toward the base 400 including the auxiliary yoke 560 thereon in a direction intersecting the optical axis (Z-axis).

Accordingly, due to the attractive force acting between the first aperture magnet 511 and the auxiliary yoke 560, the first rolling ball RB1a may be in contact with the side surface of the 1-1 guide groove 421 and the side surface of the 2-1 guide groove 321.

Due to the attractive force acting between the first aperture magnet 511 and the auxiliary yoke 560, the second rolling ball RB1b may be in contact with the side surface of the 1-2 guide groove 422 and the side surface of the 2-2 guide groove 322.

Each of the side surface of the 1-1 guide groove 421, the side surface of the 1-2 guide groove 422, the side surface of the 2-1 guide groove 321, and the side surface of the 2-2 guide groove 322 may be a curved surface.

For example, the radius of curvature of the side surface of the 1-1 guide groove 421 and the radius of curvature of the side surface of the 1-2 guide groove 422 may be the same. Also, the radius of curvature of the side surface of the 2-1 guide groove 321 and the radius of curvature of the side surface of the 2-2 guide groove 322 may be the same.

A conceptual circle passing through the side surface of the 1-1 guide groove 421 and the side surface of the 1-2 guide groove 422, and a conceptual circle passing through the side surface of the 2-1 guide groove 321 and the side surface of the 2-2 guide groove 322 may be concentric.

The auxiliary yoke 560 may be disposed on an external side in a direction perpendicular to the optical axis (Z-axis) than a conceptual circle passing through the side surface of the 1-1 guide groove 421 and the side surface of the 1-2 guide groove 422. Also, the auxiliary yoke 560 may be disposed on an external side in a direction perpendicular to the optical axis (Z-axis) rather than an imaginary circle passing through the side surface of the 2-1 guide groove 321 and the side surface of the 2-2 guide groove 322.

When a driving force is generated by the aperture driving unit 500, the first rolling ball RB1a may roll along the side surface of the 1-1 guide groove 421 and the side surface of the 2-1 guide groove 321, and the second rolling ball RB1b may roll along the side surface of the 1-2 guide groove 422 and the side surface of the 2-2 guide groove 322.

Accordingly, the rotating body 300 may rotate by being guided by the first rolling ball RB1a and the second rolling ball RB1b.

When the rotating body 300 rotates, the second rolling member RB2 may maintain to be in contact with the bottom surface of the 1-3 guide groove 423 and the bottom surface of the 2-3 guide groove 323, and the rotating body 300 may maintain to be in three-point contact with the rolling portion RB.

In an embodiment, the aperture module 2 may detect a position of the rotating body 300.

To this end, an aperture position sensor 530 may be provided. The aperture position sensor 530 may be disposed on the aperture substrate 540 to face the magnet portion 510. For example, the aperture position sensor 530 may face at least one of the first aperture magnet 511 and the second aperture magnet 512 in the optical axis (Z-axis) direction.

The aperture position sensor 530 may be a Hall sensor.

According to the aforementioned embodiments, a camera module may improve driving reliability.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a housing;
a lens module disposed in the housing and configured to move in one or more axial directions among three axes intersecting each other, the lens module comprising a lens barrel and a lens holder coupled together; and
an aperture module coupled to the lens module and configured to move together with the lens module,
wherein the lens holder comprises a first adhesive groove bonded to the lens barrel and a second adhesive groove including a portion of the aperture module accommodated therein, and
wherein a barrier member is disposed between the first adhesive groove and the second adhesive groove.

2. The camera module of claim 1, wherein the lens barrel is bonded to the lens holder by an adhesive applied to the first adhesive groove.

3. The camera module of claim 1, wherein the aperture module is bonded to the lens barrel and the lens holder by an adhesive applied to the second adhesive groove.

4. The camera module of claim 3, wherein a lower surface of the aperture module is bonded to an upper surface of the lens barrel through the adhesive.

5. The camera module of claim 4, wherein the aperture module comprises a support protrusion accommodated in the second adhesive groove, and
wherein the support protrusion is spaced apart from a bottom surface of the second adhesive groove, in an optical axial direction, while being accommodated in the second adhesive groove.

6. The camera module of claim 1, wherein the aperture module comprises a
support protrusion accommodated in the second adhesive groove, and
wherein the support protrusion is spaced apart from an internal side surface of the second adhesive groove and an external side surface of the lens barrel while being accommodated in the second adhesive groove.

7. The camera module of claim 6, wherein a distance between an internal side surface of the adhesive groove and an external side surface of the lens barrel in a direction perpendicular to an optical axis is greater than a width of the support protrusion in the direction perpendicular to the optical axis.

8. The camera module of claim 6, wherein an adhesive is applied to the second adhesive groove, and the adhesive surrounds the support protrusion.

9. The camera module of claim 8, wherein the adhesive is in contact with the internal side surface of the second adhesive groove, an external side surface of the support protrusion, and the external side surface of the lens barrel.

10. The camera module of claim 1, wherein the barrier member extends in an optical axial direction to partition the first adhesive groove and the second adhesive groove.

11. The camera module of claim 1, wherein a length of the second adhesive groove in a circumferential direction is longer than a length of the first adhesive groove in the circumferential direction.

12. The camera module of claim 1, wherein a portion of an external side surface of the lens barrel opposes the first adhesive groove and the second adhesive groove in a direction perpendicular to an optical axis.

13. The camera module of claim 1, further comprising:
a connection substrate configured to supply power to the aperture module and including a moving portion coupled to the aperture module, a fixing portion fixed to the housing, and a support portion connecting the moving portion to the fixing portion.

14. The camera module of claim 13, further comprising:
a printed circuit board coupled to the housing and on which an image sensor is disposed,
wherein the connection substrate further comprises a connection portion connecting the fixing portion to the printed circuit board.

15. The camera module of claim 1, wherein the aperture module comprises:
a base;
a rotating body configured to rotate with respect to the base;
a plurality of blades configured to move in conjunction with rotation of the rotating body to form an aperture;
a magnet portion disposed on one of the base and the rotating body;
a coil portion disposed to face the magnet portion; and
an aperture substrate on which the coil portion is disposed.

16. The camera module of claim 15, further comprising:
a printed circuit board coupled to the housing and on which an image sensor is disposed; and
a connection substrate having one side connected to the aperture substrate and another side connected to the printed circuit board.

17. The camera module of claim 1, wherein the aperture module and the lens module are configured to move together in an optical axial direction, a first axial direction perpendicular to the optical axial direction, and a second axial direction perpendicular to both the optical axial direction and the first axial direction.
